(19) United States
(12) Patent Application Publication
(10) Pub. No.: US 2021/0027967 A1
(43) Pub. Date: Jan. 28, 2021

(54) TRANSPARENT LABEL INDICATOR OF A RESIDENTIAL CIRCUIT BREAKER

(71) Applicant: Siemens Industry, Inc., Alpharetta, GA (US)

(72) Inventors: Russell Thomas Watford, Lawrenceville, GA (US); Joselito Endozo, Dacula, GA (US)

(21) Appl. No.: 16/519,911

(22) Filed: Jul. 23, 2019

(51) Int. Cl. H01H 71/04; H01H 71/02; H01H 71/06

(52) U.S. Cl. CPC H01H 71/04; H01H 71/06; H01H 71/025

(57) ABSTRACT

A residential circuit breaker is provided with means to visually identify certain status information about the device such as detection of a condition through a label. The residential circuit breaker comprises an electronic pole housing that includes an opening for a light emitting diode (LED) light to pass through. The residential circuit breaker comprises the label located on a front of the residential circuit breaker such that the label is used to identify device information about the residential circuit breaker. The label includes a window in a specified area for the LED light to shine through the label to provide an arc fault circuit interrupter (AFCI)/a ground-fault circuit interrupter (GFCI) indication. The residential circuit breaker further comprises a LED mounted on a printed circuit board (PCB) assembly to transmit the light from the LED to an external surface of the circuit breaker without the need of a translucent plastic part.

### BACKGROUND

### 1. Field

Aspects of the present invention generally relate to a transparent label indicator of a Residential Circuit Breaker.

### 2. Description of the Related Art

A typical arc fault circuit interrupter (AFCI)/ground fault circuit interrupter (GFCI) residential circuit breaker includes a mechanical and an electronic pole. The electronic pole includes a printed circuit board (PCB) assembly with a PCB LED component(s) and a transparent plastic part. The PCB LED(s) will light up under certain conditions. For example, upon an Arc Fault or Ground Fault detection. The PCB LED typically is mounted such that light coming from the LED is 90 degrees to the PCB. A translucent plastic part is used to transmit light from the PCB LED through the transparent plastic part and to a front surface of the circuit breaker. The PCB LED is internal to the circuit breaker and the transparent plastic part is used to bend the generated light from the LED and show it to the external surfaces of the circuit breaker.

The existing Residential Circuit Breaker designs use a transparent plastic part to transmit the LED light from the PCB LED to the front of the circuit breaker. The LED is mounted so that the LED light is perpendicular to the PCB. This requires a translucent plastic part to direct the LED light to the front of the circuit breaker. This adds costs to the circuit breaker for the translucent part, additional assembly time, ongoing incoming part inspection, tool cost and maintenance.

Therefore, there is a need for a simplified means to transmit the light from a LED to an external surface of a circuit breaker.

### SUMMARY

Briefly described, aspects of the present invention relate to circuit breakers typically having a label on the front of the device. This label is used to identify certain information about the device. The present invention uses this label to include and a portion that is clear/transparent for a light emitting diode (LED) light to be visible when activated. A portion of the label would include a clear area so that the LED light can shine thru the label to provide an AFCI/a GFCI indication. This is a simplified means to transmit the light from a PCB LED to an external surface of a circuit breaker without the need of a translucent plastic part. The advantage of this application is focused on reducing cost and improve manufacturing assembly processes, time and reduce tool cost and maintenance.

In accordance with one illustrative embodiment of the present invention, a residential circuit breaker is provided. It comprises an electronic pole housing that includes an opening for a light emitting diode (LED) light to pass through. The residential circuit breaker further comprises a label located on a front of the residential circuit breaker such that the label is used to identify device information about the residential circuit breaker. The label includes a window in a specified area for the LED light to shine through the label to provide an arc fault circuit interrupter (AFCI)/a ground-fault circuit interrupter (GFCI) indication. The residential circuit breaker further comprises a LED mounted on a printed circuit board (PCB) assembly to transmit the light from the LED to an external surface of the residential circuit breaker without the need of a translucent plastic part.

In accordance with another illustrative embodiment of the present invention, a method of transmitting light from a light emitting diode (LED) to an external surface of a residential circuit breaker is provided. The method comprises providing an electronic pole housing that includes an opening for a LED light to pass through. The method further comprises providing a label located on a front of the residential circuit breaker such that the label is used to identify device information about the residential circuit breaker. The label includes a window in a specified area for the LED light to shine through the label to provide an arc fault circuit interrupter (AFCI)/a ground-fault circuit interrupter (GFCI) indication. The method further comprises providing the LED mounted on a printed circuit board (PCB) assembly to transmit the light from the LED to the external surface of the residential circuit breaker without the need of a translucent plastic part.

### BRIEF DESCRIPTION OF THE DRAWINGS

FIG. 1 illustrates a block diagram of a residential circuit breaker (RCB) with a label that includes a portion that is clear/transparent for a light emitting diode (LED) light to be visible when a LED is activated to provide an AFCI/a GFCI indication in accordance with an exemplary embodiment of the present invention.

FIG. 2 illustrates a block diagram of a residential circuit breaker (RCB) with a label that includes a clear/transparent window in accordance with an exemplary embodiment of the present invention.

FIG. 3 illustrates an exploded view of the residential circuit breaker (RCB) of FIG. 2 in accordance with an exemplary embodiment of the present invention.

FIG. 4 illustrates a cross-sectional view of the residential circuit breaker (RCB) of FIG. 2 at a line A-A′ in accordance with an exemplary embodiment of the present invention.

FIG. 5 illustrates a schematic view of a label of a residential circuit breaker (RCB) in accordance with an exemplary embodiment of the present invention.

FIG. 6 illustrates a schematic view of a flow chart of a method of transmitting light from a light emitting diode (LED) to an external surface of a residential circuit breaker in accordance with an exemplary embodiment of the present invention.

### DETAILED DESCRIPTION

To facilitate an understanding of embodiments, principles, and features of the present invention, they are explained hereinafter with reference to implementation in illustrative embodiments. In particular, they are described in the context of a label that includes a portion that is clear/transparent for a LED light to be visible when the LED is activated. A portion of the label would need to include a clear part so that the LED light can shine through the label to provide an AFCI/a GFCI indication. This is first accomplished by replacing the LED so that the light is projected parallel to the PCB rather than 90 degrees to the PCB. Second a transparent plastic part is removed and replaced with a label that includes a clear window for the PCB LED light to shine through. An electronic pole housing would include an opening for the LED light to pass through. The label would be a modification to an existing label that is required to be located on a front region of a circuit breaker surface. Switching to a label LED indication method, a circuit breaker manufacturer would no longer need to source for tooling, maintain tool maintenance, additional time needed for incoming inspections, control part inventory for the transparent plastic part. This will decrease assembly time and reduce overall manufacturing cost to develop a Residential Circuit Breaker. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

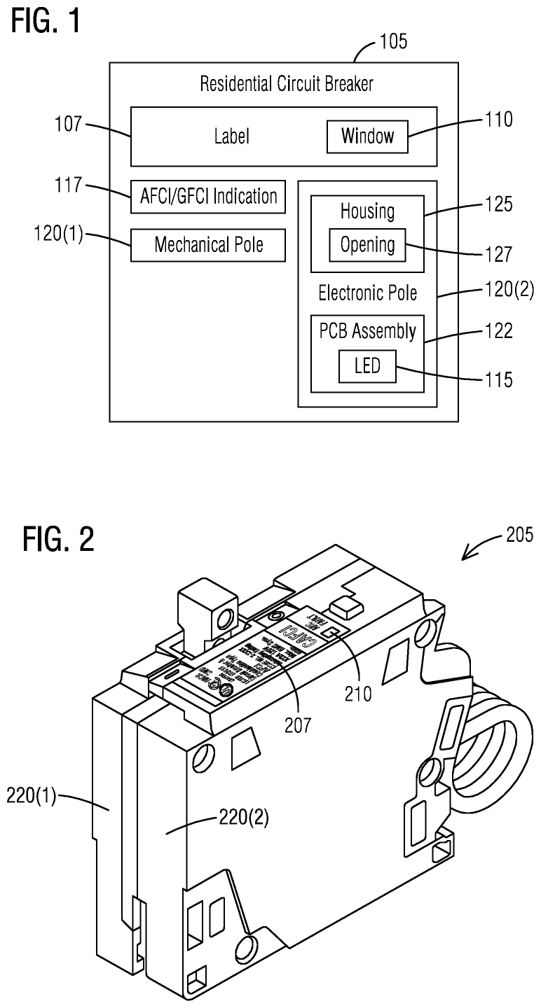

These and other embodiments of the Residential Circuit Breaker with a label having a clear/transparent window for a LED light to go through it according to the present disclosure are described below with reference to FIGS. 1-6 herein. Like reference numerals used in the drawings identify similar or identical elements throughout the several views. The drawings are not necessarily drawn to scale.

Consistent with one embodiment of the present invention, FIG. 1 represents a block diagram of a residential circuit breaker (RCB) 105 in accordance with an exemplary embodiment of the present invention. The residential circuit breaker (RCB) 105 includes a label 107 that includes a portion that is clear/transparent defined as a window 110 for a light emitting diode (LED) light 112 to be visible when a LED 115 is activated to provide an AFCI/a GFCI indication 117 in accordance with an exemplary embodiment of the present invention. The label 107 may be located on a front of the residential circuit breaker 105 such that the label 107 is used to identify device information about the residential circuit breaker 105. The label 107 includes the window 110 in a specified area for the LED light 112 to shine through the label 107 to provide the arc fault circuit interrupter (AFCI) or the ground-fault circuit interrupter (GFCI) indication 117. The label 107 comprises a metallic backing that includes the specified area that has the window 110. The window 110 of the label 107 to include a portion that is clear for the LED light 112 to be visible when the LED 115 is activated.

Examples of the residential circuit breaker (RCB) 105 include an arc fault circuit interrupter (AFCI) residential circuit breaker and a ground fault circuit interrupter (GFCI) residential circuit breaker. The residential circuit breaker (RCB) 105 includes a mechanical pole 120(1) and an electronic pole 120(2). The electronic pole 120(2) includes a printed circuit board (PCB) assembly 122 with a PCB LED component(s) including the LED 115. The LED 115 will light up under certain conditions. For example, upon an Arc Fault or Ground Fault detection. The window 110 is used to transmit light from the LED 115 through the label 107 and to a front surface of the circuit breaker 105. The LED 115 may be mounted on the printed circuit board (PCB) assembly 122 to transmit the light from the LED 115 to an external surface of the residential circuit breaker 105 without the need of a translucent plastic part.

The electronic pole 120(2) comprises an electronic pole housing 125 that includes an opening 127 for the light emitting diode (LED) light 112 to pass through. The electronic pole housing 125 may be made of plastic that includes the opening 127 for the LED light 112 to pass through. The opening 127 in the electronic pole housing 125 and the window 110 in the label 107 are aligned centrally along a single axis to provide a means to transmit light from the LED 115 to an external surface of the residential circuit breaker 105 without the use of a transparent plastic light guide or a fiber cable.

The residential circuit breaker 105 further comprises circuitry 130 capable of detecting the AFCI or the GFCI condition 117. The detection of the AFCI or the GFCI condition 117 illuminates the LED 115 mounted on the PCB assembly 122. The LED 115 is mounted to the PCB assembly 122 in such a way that the LED 115 projects a light parallel or perpendicular to the PCB assembly 122.

Referring to FIG. 2, it illustrates a block diagram of a residential circuit breaker (RCB) 205 with a label 207 that includes a clear/transparent window 210 in accordance with an exemplary embodiment of the present invention. The residential circuit breaker 205 may be an arc fault circuit interrupter (AFCI). The residential circuit breaker 205 may be a ground-fault circuit interrupter (GFCI). The residential circuit breaker (RCB) 205 includes a mechanical pole 220(1) and an electronic pole 220(2). The electronic pole 220(2) includes a printed circuit board (PCB) assembly (not seen) with a PCB LED component(s) including a LED (not seen). The LED will light up under certain conditions. For example, upon an Arc Fault or Ground Fault detection.

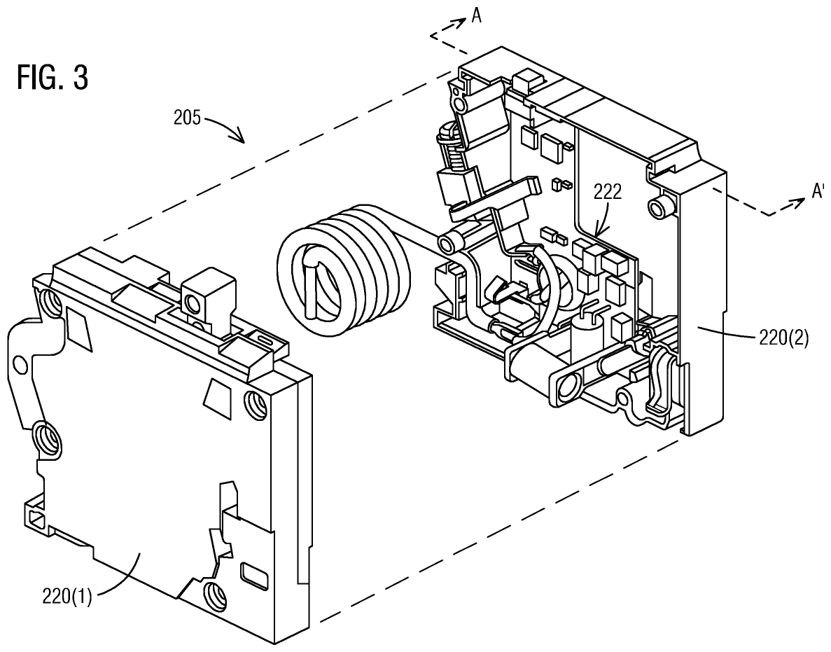

Turning now to FIG. 3, it illustrates an exploded view of the residential circuit breaker (RCB) 205 of FIG. 2 in accordance with an exemplary embodiment of the present invention. The residential circuit breaker (RCB) 205 includes the mechanical pole 220(1) and the electronic pole 220(2). The electronic pole 220(2) includes a printed circuit board (PCB) assembly 222 with a PCB LED component(s) including a LED (not seen). The LED will light up under certain conditions. For example, upon an Arc Fault or Ground Fault detection. The window 210 is used to transmit light from the LED through the label 207 and to a front surface of the circuit breaker 205. The LED may be mounted on the printed circuit board (PCB) assembly 222 to transmit the light from the LED to an external surface of the residential circuit breaker 205 without the need of a translucent plastic part.

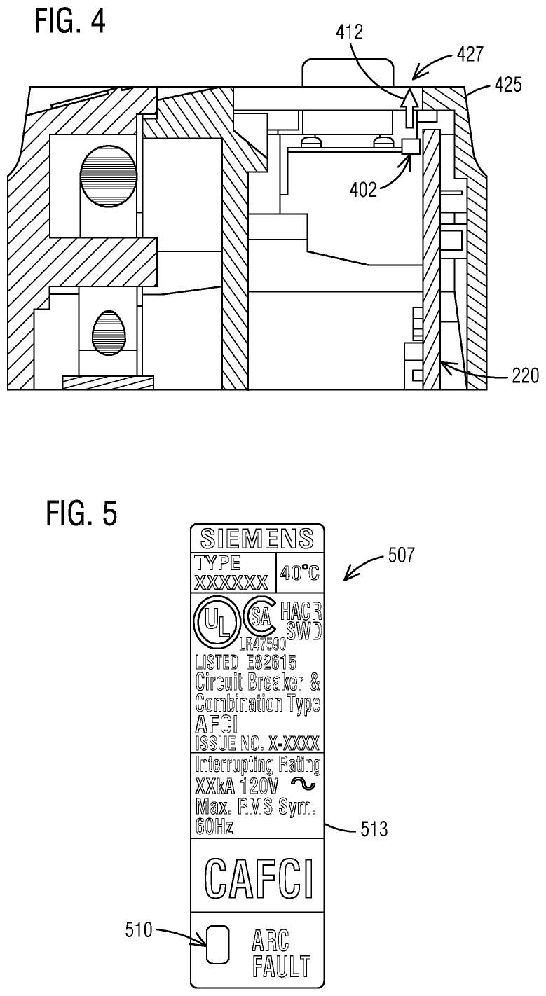

FIG. 4 illustrates a cross-sectional view of the residential circuit breaker (RCB) 205 of FIG. 2 at a line A-A′ in accordance with an exemplary embodiment of the present invention. The electronic pole 220(2) includes the printed circuit board (PCB) assembly 222 with a PCB LED component(s) including a LED 402. The LED 402 will light up under certain conditions. For example, upon an Arc Fault or Ground Fault detection. The window 210 is used to transmit light from the LED 402 through the label 207 and to a front surface of the circuit breaker 205. The LED 402 may be mounted on the printed circuit board (PCB) assembly 222 to transmit the light from the LED 402 to an external surface of the residential circuit breaker 205 without the need of a translucent plastic part.

The electronic pole 220(2) comprises an electronic pole housing 425 that includes an opening 427 for a light emitting diode (LED) light 412 to pass through. The electronic pole housing 425 may be made of plastic that includes the opening 427 for the LED light 412 to pass through. The opening 427 in the electronic pole housing 425 and the window 210 in the label 207 are aligned centrally along a single axis to provide a means to transmit light from the LED 402 to an external surface of the residential circuit breaker 205 without the use of a transparent plastic light guide or a fiber cable.

As seen in FIG. 5, it illustrates a schematic view of a label 507 of a residential circuit breaker (RCB) in accordance with an exemplary embodiment of the present invention. The label 507 may be located on a front of the residential circuit breaker 105 such that the label 507 is used to identify device information about the residential circuit breaker 105. The label 507 includes a window 510 in a specified area for a LED light to shine through the label 507 to provide the arc fault circuit interrupter (AFCI) or the ground-fault circuit interrupter (GFCI) indication 117. The label 507 comprises a metallic backing 513 that includes the specified area that has the window 510. The window 510 of the label 507 to include a portion that is clear for the LED light to be visible when a LED is activated.

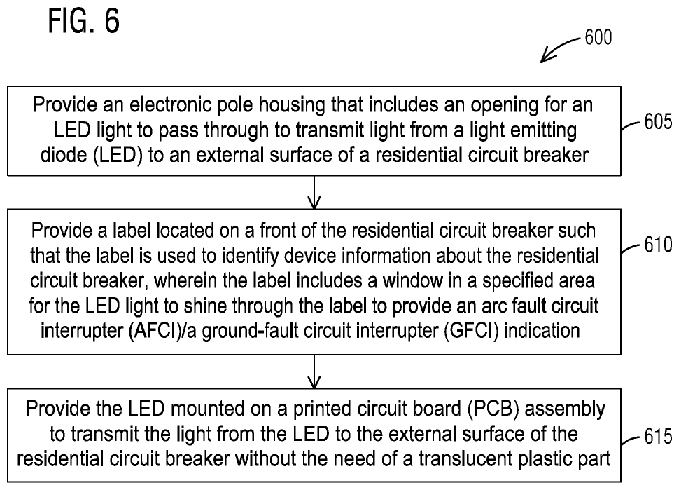

FIG. 6 illustrates a schematic view of a flow chart of a method 600 of transmitting light from a light emitting diode (LED) to an external surface of a residential circuit breaker in accordance with an exemplary embodiment of the present invention. Reference is made to the elements and features described in FIGS. 1-5. It should be appreciated that some steps are not required to be performed in any particular order, and that some steps are optional.

For transmitting light from a light emitting diode (LED) to an external surface of the residential circuit breaker 105, the method 600 in step 605 provides an electronic pole housing that includes an opening for a LED light to pass through. The method 600 in step 610 further provides the label 107 located on a front of the residential circuit breaker 105 such that the label 107 is used to identify device information about the residential circuit breaker 105. The label 107 includes the window 110 in a specified area for the LED light to shine through the label 107 to provide the arc fault circuit interrupter (AFCI)/the ground-fault circuit interrupter (GFCI) indication 117. The method 600 in step 615 further provides the LED 115 mounted on the printed circuit board (PCB) assembly 122 to transmit the light from the LED 115 to the external surface of the residential circuit breaker 105 without the need of a translucent plastic part.

A one or two pole AFCI or GFCI residential circuit breaker design comprises a front label with a specified area that is clear or transparent. AFCI or GFCI circuit breaker that is capable of detecting an AFCI or GFCI condition. The AFCI or GFCI detection illuminates an LED mounted on the PCB assembly. The LED is mounted to the PCB assembly such that the LED projects the light parallel not perpendicular to the PCB assembly.

One advantage of the present invention is to reduce tooling and maintenance cost and improve manufacturability and assembly time. A production tool can cost between $10-$15 for such a tool. Any costs associated with tool maintenance and or incoming inspections can be eliminated. The molder must maintain a certain level of translucency (clearness) otherwise units may not pass manufacturing test and devices rejected thus possibly missing shipments to the distribution centers.

While a residential circuit breaker is described here a range of one or more other circuit breaker means or other forms of circuit breakers are also contemplated by the present invention. For example, other types of circuit breakers may be implemented based on one or more features presented above without deviating from the spirit of the present invention.

The techniques described herein can be particularly useful for the arc fault circuit interrupter (AFCI)/the ground-fault circuit interrupter (GFCI) indication. While particular embodiments are described in terms of an arc fault circuit interrupter (AFCI)/a ground-fault circuit interrupter (GFCI) indication, the techniques described herein are not limited to such a structure but can also be used with other electrical structures or configurations.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

1. A residential circuit breaker comprising:
an electronic pole housing that includes an opening for a light emitting diode (LED) light to pass through;
an opaque label located on a front of the residential circuit breaker such that the label is used to identify device information about the residential circuit breaker,
wherein the label includes a window in a specified area for the LED light to shine through the window while being blocked by opaqueness of the label to provide an arc fault circuit interrupter (AFCI)/a ground-fault circuit interrupter (GFCI) indication as the label completely blocks the LED light and allows the LED light to go through only through the window; and
a LED mounted on a printed circuit board (PCB) assembly to transmit the light from the LED to an external surface of the residential circuit breaker without the need of a translucent plastic part.

2. The residential circuit breaker of claim 1, further comprising:
circuitry capable of detecting an AFCI or a GFCI condition.

3. The residential circuit breaker of claim 2, wherein detection of the AFCI or the GFCI condition illuminates the LED mounted on the PCB assembly.

4. The residential circuit breaker of claim 3, wherein the LED is mounted to the PCB assembly in such a way that the LED projects a light parallel or perpendicular to the PCB assembly.

5. The residential circuit breaker of claim 1, wherein the electronic pole housing is made of plastic that includes the opening for the LED light to pass through.

6. The residential circuit breaker of claim 1, wherein the label comprises a metallic backing that includes the specified area that has the window.

7. The residential circuit breaker of claim 1, wherein the window of the label to include a portion that is clear for the LED light to be visible when the LED is activated.

8. The residential circuit breaker of claim 1, wherein the opening in the electronic pole housing and the window in the label are aligned centrally along a single axis to provide a means to transmit light from the LED to an external surface of the residential circuit breaker without the use of a transparent plastic light guide or a fiber cable.

9. The residential circuit breaker of claim 1, wherein the residential circuit breaker is an arc fault circuit interrupter (AFCI).

10. The residential circuit breaker of claim 1, wherein the residential circuit breaker is a ground-fault circuit interrupter (GFCI).

11. A method of transmitting light from a light emitting diode (LED) to an external surface of a residential circuit breaker, the method comprising:
providing an electronic pole housing that includes an opening for a LED light to pass through;
providing an opaque label located on a front of the residential circuit breaker such that the label is used to identify device information about the residential circuit breaker,
wherein the label includes a window in a specified area for the LED light to shine through the window while being blocked by opaqueness of the label to provide an arc fault circuit interrupter (AFCI)/a ground-fault circuit interrupter (GFCI) indication as the label completely blocks the LED light and allows the LED light to go through only through the window; and
providing the LED mounted on a printed circuit board (PCB) assembly to transmit the light from the LED to the external surface of the residential circuit breaker without the need of a translucent plastic part.

12. The method of claim 11, further comprising:
providing circuitry capable of detecting an AFCI or a GFCI condition.

13. The method of claim 12, wherein detection of the AFCI or the GFCI condition illuminates the LED mounted on the PCB assembly.

14. The method of claim 13, wherein the LED is mounted to the PCB assembly in such a way that the LED projects a light parallel or perpendicular to the PCB assembly.

15. The method of claim 11, wherein the electronic pole housing is made of plastic that includes the opening for the LED light to pass through.

16. The method of claim 11, wherein the label comprises a metallic backing that includes the specified area that has the window.

17. The method of claim 11, wherein the window of the label to include a portion that is clear for the LED light to be visible when the LED is activated.

18. The method of claim 11, wherein the opening in the electronic pole housing and the window in the label are aligned centrally along a single axis to provide a means to transmit light from the LED to an external surface of the residential circuit breaker without the use of a transparent plastic light guide or a fiber cable.

19. The method of claim 11, wherein the residential circuit breaker is an arc fault circuit interrupter (AFCI).

20. The method of claim 11, wherein the residential circuit breaker is a ground-fault circuit interrupter (GFCI).
